(19) United States
(12) Patent Application Publication
(10) Pub. No.: US 2010/0151438 A1
(43) Pub. Date: Jun. 17, 2010

(54) METHODS AND KITS FOR ENHANCING SEDIMENTATION AND RECOVERY OF CELLS IN A SAMPLE

(75) Inventors: Liming Yu, Clifton Park, NY (US); Hongyi Zhou, Niskayuna, NY (US); Nichole Lee Wood, Niskayuna, NY (US); Anup Sood, Clifton Park, NY (US); Reginald Donovan Smith, Schenectady, NY (US); Brian David Polizzotti, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/333,926

(22) Filed: Dec. 12, 2008

(51) Int. Cl. A01N 1/02

(52) U.S. Cl. 435/2

(57) ABSTRACT

The methods and kits provide sedimentation-enhancing agents that significantly increase the efficiency of cell-sedimentation. They also increase the efficiency of blood cell separation methods and thereby increase the recovery of total nucleated cells.

### FIELD

This invention generally relates to sedimentation of blood cells and to recovery of nucleated cells from a blood sample.

### BACKGROUND

Separation of red blood cells (RBC) from whole blood is commonly required prior to analysis or therapeutic use of less abundant cells, such as white blood cells or stem cells. Many conventional blood cell isolation procedures require preliminary red blood cell depletion and sample volume reduction. These steps are commonly performed in long-term cell banking and regenerative medicinal applications, where a maximal yield of blood cells is desired in a reduced volume for direct transplantation or storage for future use.

Sedimentation methods, either via gravity or centrifugation, are known in the art for separating different components of blood. One method to facilitate sedimentation of RBCs from whole blood is to use polymeric large molecules, such as dextran, hetastarch, or gelatin, which are known aggregating agent for RBCs. Depending on the composition and stoichiometric ratio of the aggregating agent in blood, the speed and effectiveness of the RBC sedimentation process can vary widely. Some of the sedimentation-enhancing agents are known, such as potassium oxalate and potassium malonate. The effectiveness of these sedimentation-enhancing agents is largely determined by the concentration of the agent relative to the blood sample. Although potassium oxalate and malonate have previously been demonstrated as effective RBC sedimentation enhancing agents, the clinical utility of these agents is limited by the potential cardiovascular toxicity associated with potassium salt.

### BRIEF DESCRIPTION

In general, the methods and kits of the invention provide sedimentation-enhancing agents that are biocompatible and significantly increase the efficiency of blood separation methods and systems and thereby increase the recovery of total nucleated cells (TNC). At the concentration range specified, these sedimentation-enhancing agents are considered non-toxic and safe to use in vivo.

One or more examples of the method to sediment cells in a sample comprising blood cells comprises adding an aggregating agent; and a non-toxic enhancer having a final concentration range from about 10 mM to about 100 mM.

In some of the examples of the method to sediment cells is provided in a sample comprising blood cells comprises addition of an aggregating agent and the non-toxic enhancer comprises sodium citrate or sodium succinate or a combination thereof.

In some embodiments of the kit to sediment cells, the kit comprises an aggregating agent; and a non-toxic enhancer wherein the non-toxic enhancer comprises sodium citrate or sodium succinate or a combination thereof.

In some embodiments of the kit to sediment cells, the kit comprises an aggregating agent wherein the aggregating agent is selected from the group consisting of dextran, hetastarch or gelatin and a non-toxic enhancer wherein the non-toxic enhancer comprises sodium citrate or sodium succinate or a combination thereof.

Some embodiments of the method to sediment cells improve the resulting recovery of an increased percentage of total nucleated cells from a sample comprising red blood cells, wherein the method comprises the steps of adding an aggregating agent, a non-toxic enhancer, incubating the sample to aggregate plurality of RBCs, and recovering the total nucleated cells.

### FIGURES

These and other features, aspects, and advantages of the present invention will become better understood when the following detailed description is read with reference to the accompanying figures.

FIG. 1 is a graph and table showing examples of the volume of recovered TNC for dextran alone, dextran combined with sodium citrate and dextran combined with sodium succinate.

FIG. 2 is a graph showing an example of the sedimentation efficiency of sodium citrate.

### DETAILED DESCRIPTION

The following detailed description is exemplary and not intended to limit the invention of the application and uses of the invention. Furthermore, there is no intention to be limited by any theory presented in the preceding background of the invention on the following detailed description. To more clearly and concisely describe and point out the subject matter of the claimed invention, the following definitions are provided for specific terms that are used in the following description and the claims appended hereto.

Unless otherwise indicated, the article “a” refers to one or more than one of the word modified by the article “a.” Unless otherwise indicated, all numbers expressing quantities of ingredients, properties such as molecular weight, reaction conditions, so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

“Aggregating agent” is referred to herein as the molecules that help to facilitate aggregation of blood cells. Examples of aggregating agents include, but are not limited to, high molecular weight polymeric molecules such as certain proteins like fibrinogen or gamma globulin; gelatin, and certain polysaccharides like dextran, hetastarch, pentastarch, and poly ethylene glycol (PEG).

“Kit” is referred to herein as one or more reactants necessary for a given assay or test, set of directions to use the reactants present in the kit, any buffers necessary to maintain reaction conditions and other optional materials such as spin column or eppendorf tube.

The methods and kits of the invention to sediment blood cells generally comprise adding one or more non-toxic enhancers, such as sodium citrate or sodium succinate, to accelerate RBC sedimentation. Since, sodium citrate and sodium succinate have already been parenterally used in medical practices, the non-toxic enhancers of these methods and kits are safe for human in vivo applications and the recovered cells after sedimenting RBC may be used for therapeutic purposes.

One or more examples of the methods for enhancing sedimentation of red blood cells increase the recovery of highly purified cells such as TNCs having high cell viability that is desirable for various therapeutic applications.

The non-toxic enhancers used in one or more of the methods increase the rate of sedimentation. Non-limiting examples of non-toxic enhancers used in one or more of the methods are sodium citrate, sodium succinate and combinations thereof.

In some examples, the method to sediment cells comprises providing a sample comprising blood cells treated by adding an aggregating agent and a non-toxic enhancer in various concentration ranges. Examples of suitable concentration ranges include, but are not limited to 10 mM to 100 mM, 12.5 mM to 75 mM, 25 mM to 75 mM, and 50 mM to 75 mM.

In some examples, a method to sediment cells in a sample includes providing blood cells that are treated by addition of an aggregating agent and a non-toxic enhancer having a final concentration ranges from about 12.5 mM to about 100 mM, wherein the non-toxic enhancer is sodium citrate, sodium succinate or a combination thereof. In some embodiments, the aggregating agent comprises dextran and the non-toxic enhancer comprises sodium citrate, sodium succinate or a combination thereof.

One or more of the embodiments of the kit to sediment cells comprises an aggregating agent; and a non-toxic enhancer. One or more of the embodiments of the kit for aggregating cells comprises an aggregating agent, and a non-toxic enhancer wherein the non-toxic enhancers comprise sodium citrate or sodium succinate or a combination thereof. One or more of the embodiments of the kit for aggregating cells comprises an aggregating agent wherein the aggregating agent is dextran, and a non-toxic enhancer.

The methods of recovering cells with high purity and viability generally use an aggregating agent in combination with a non-toxic enhancer for sedimentation. For example, in one of the examples, a sample that includes red blood cells, is treated by adding an aggregating agent and a non-toxic enhancer, followed by incubation of the sample, and eventual recovery of the TNCs.

One or more of the methods of recovering a percentage of TNCs from a sample comprising red blood cells comprises adding an aggregating agent and a non-toxic enhancer at a predetermined concentration followed by incubation of the sample, and eventually recovering of the total nucleated cells. In certain embodiments, the enhancer is sodium citrate or sodium succinate or a combination thereof.

### EXAMPLES

Practice of the invention will be more fully understood from the following examples, which are presented herein for illustration only and should not be construed as limiting the invention in any way.

### Example 1

Materials: Human peripheral blood was used for the experiments. The dextran T500 used in this example was obtained from Pharmacosmos A/s, Denmark; sodium citrate dihydrate was obtained from J T Baker; and sodium succinate was obtained from Sigma, St. Louise, Mo.

The extent of red blood cell aggregation was measured in vitro in the presence of different biocompatible enhancers. A control sample, without an aggregation enhancer, was prepared by mixing 2.4 ml of a blood sample with 2.4 ml of phosphate buffered saline (PBS) containing 3% Dextran T500, and then incubated (the final concentration of dextran was 1.5%). Two test samples were also prepared. The first test sample was prepared by mixing 2.4 ml of the blood sample with 2.4 ml of PBS containing 3% Dextran T500 and 100 mM sodium citrate, and then incubated (the final concentration of dextran was 1.5% and the final concentration of sodium citrate was 50 mM). The second test sample was prepared by mixing 2.4 ml of the blood sample with 2.4 ml of PBS containing 3% Dextran T500 and 100 mM sodium succinate, and then incubated (the final concentration of dextran was 1.5% and the final concentration of sodium succinate was 50 mM). The incubation time for the control and test samples was about 20 minutes, at room temperature.

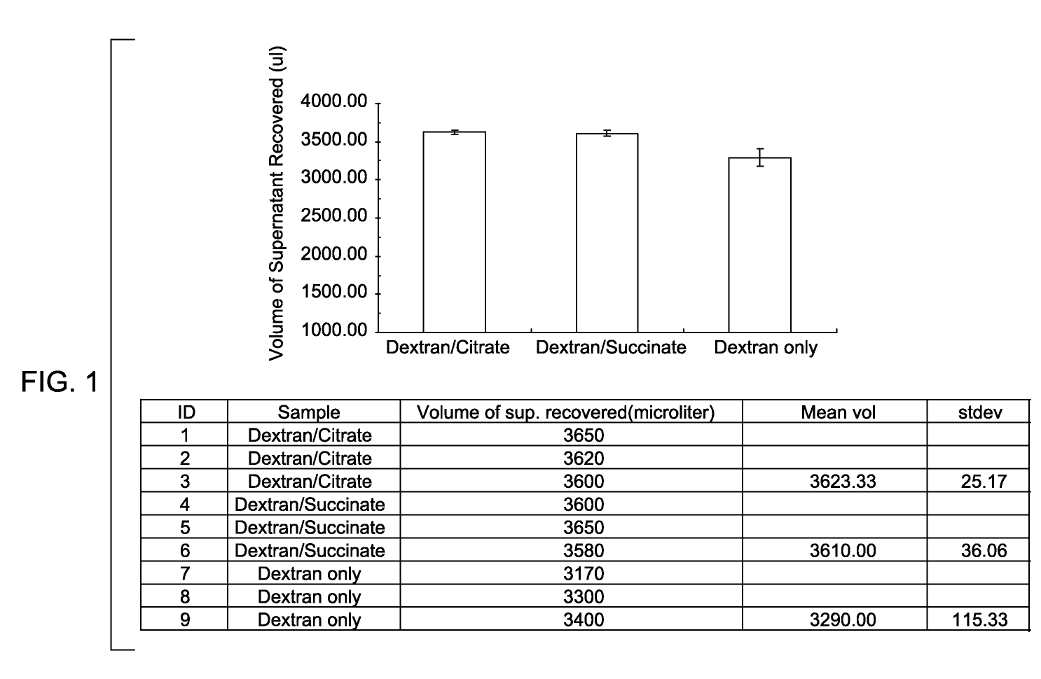

After sedimentation of red blood cells, the supernatant was recovered. The volume of the supernatant recovered was then measured. Each experiment was repeated three times (n=3) and the standard deviation for each set was calculated. The final data is presented as a bar graph in FIG. 1. The higher value of standard deviation for the control (only dextran) is likely due to less compaction and the reduced recovery of supernatant.

FIG. 1 depicts an example of the effect of sodium citrate and sodium succinate on red blood cell aggregation. The volume of supernatant recovered in the presence of dextran, serves as a control, to which the volume of supernatant recovered in the presence of sodium citrate and dextran or in the presence of sodium succinate and dextran are compared. The extent of aggregation reflects the recovered supernatant volume. Increased compaction leads to better aggregation resulting in better supernatant recovery. The experiment was performed at room temperature and the incubation time for aggregation in this example was about 20 min.

### Example 2

The efficiency of red blood cell aggregation was measured in vitro in the presence of varying concentration of non-toxic enhancer. A blood sample incubated with 1.5% Dextran T500, without an enhancer, served as a control. The control sample was prepared by mixing 2.0 ml of the blood sample with 2.0 ml of PBS containing 3% Dextran T500. Blood samples containing 1.5% Dextran T500 and 12.5 mM, 25 mM, 50 mM, 75 mM and 100 mM of sodium citrate as the enhancer served as the test samples. The test samples were prepared by mixing 2.0 ml of blood sample with 2.0 ml of PBS containing 3.0% Dextran T500 and 25 mM, 50 mM, 100 mM and 150 mM of sodium citrate, respectively, to reach final concentrations of 1.5% for dextran in each test sample, and 12.5 mM, 25 mM, 50 mM and 75 mM, for the respective test samples. The samples for control and test sets were incubated for 20 minutes, at room temperature.

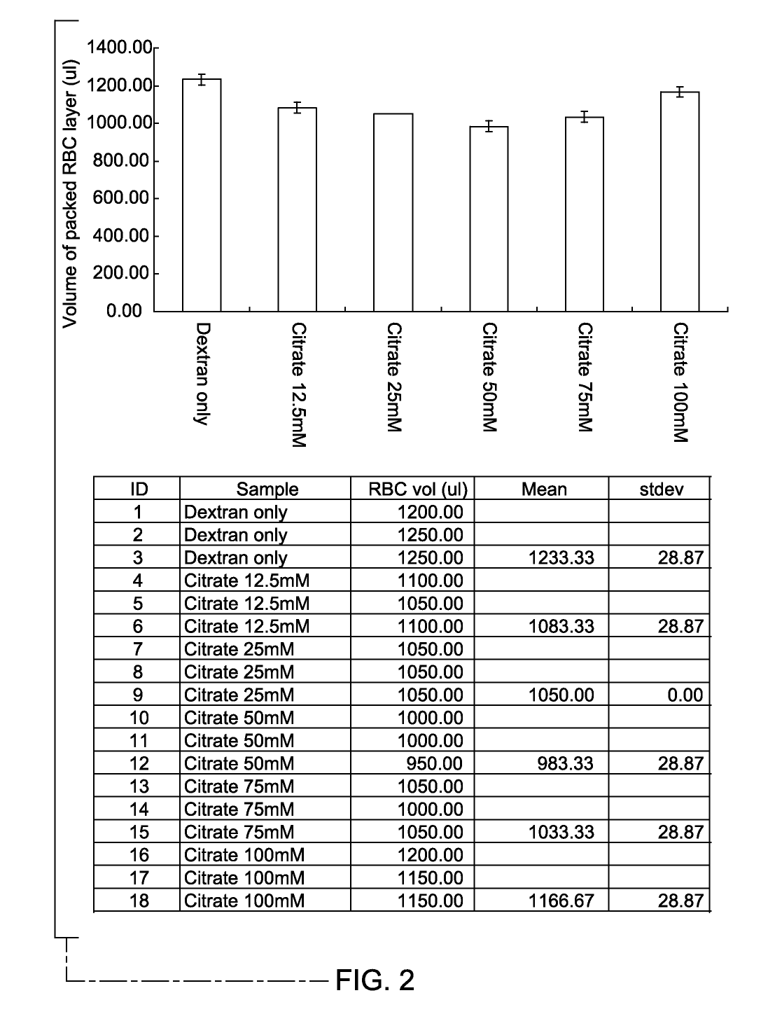

After sedimentation of red blood cells, the fluid was recovered. The volume of the supernatant recovered was then measured. Each experiment was repeated three times (n=3) and the standard deviation for each set was calculated. The final data is presented as a bar graph in FIG. 2.

The methods of aggregating blood cells may be used in connection with the system and methods described in U.S. patent application Ser. No. 12/325,672, entitled SYSTEMS AND METHODS FOR PROCESSING COMPLEX BIOLOGICAL MATERIALS, which is hereby incorporated by reference.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method to sediment cells in a sample comprising blood cells, comprising the steps of:
adding an aggregating agent; and
adding a non-toxic enhancer having a final concentration ranges from about 10 mM to about 100 mM.

2. The method of claim 1, wherein the non-toxic enhancer is sodium citrate or sodium succinate or a combination thereof.

3. The method of claim 1, wherein the concentration of the non-toxic enhancer ranges from about 12.5 mM to about 75 mM.

4. The method of claim 1, wherein the concentration of the non-toxic enhancer ranges from about 25 mM to about 75 mM.

5. The method of claim 1, wherein the concentration of the non-toxic enhancer ranges from about 50 mM to about 75 mM.

6. The method of claim 1, wherein the aggregating agent is selected from the group consisting of dextran, hetastarch or gelatin and the non-toxic enhancer comprises sodium citrate or sodium succinate or a combination thereof.

7. A method to sediment cells in a sample comprising blood cells, comprising the steps of:
adding an aggregating agent, and
adding sodium citrate or sodium succinate or a combination thereof.

8. The method of claim 7, wherein the concentration of the non-toxic enhancer ranges from about 10 mM to about 100 mM.

9. The method of claim 7, wherein the concentration of the non-toxic enhancer ranges from about 12.5 mM to about 75 mM.

10. The method of claim 7, wherein the concentration of the non-toxic enhancer ranges from about 25 mM to about 75 mM.

11. The method of claim 7, wherein the concentration of the non-toxic enhancer ranges from about 50 mM to about 75 mM.

12. The method of claim 7, wherein the aggregating agent is selected from the group consisting of dextran, hetastarch or gelatin and the non-toxic enhancer comprises sodium citrate or sodium succinate or a combination thereof.

13. A kit to sediment cells, in a sample comprising blood cells, comprising:
an aggregating agent; and
a non-toxic enhancer.

14. The kit of claim 13, wherein the non-toxic enhancer is sodium citrate or sodium succinate or a combination thereof.

15. The kit of claim 13, wherein the aggregating agent is dextran.

16. The kit of claim 13, wherein the aggregating agent is selected from the group consisting of dextran, hetastarch or gelatin.

17. A method of recovering a percentage of total nucleated cells from a sample comprising red blood cells, comprising the steps of:
adding an aggregating agent and a non-toxic enhancer,
incubating the sample to allow a plurality of red blood cells to aggregate, and
recovering the total nucleated cells.

18. The method of claim 17, wherein the non-toxic enhancer is sodium citrate or sodium succinate or a combination thereof.

19. The method of claim 17, wherein the non-toxic enhancer has a final concentration ranges from about 10 mM to about 100 mM.

20. The method of claim 17, wherein the non-toxic enhancer has a final concentration ranges from about 12.5 mM to about 75 mM.

21. The method of claim 17, wherein the non-toxic enhancer has a final concentration ranges from about 25 mM to about 75 mM.

22. The method of claim 17, wherein the non-toxic enhancer has a final concentration ranges from about 50 mM to about 75 mM.
